(19) United States
(12) Patent Application Publication
(10) Pub. No.: US 2020/0357568 A1
(43) Pub. Date: Nov. 12, 2020

(54) Winding Arrangement for at Least Two Interleaved-Switching Power-Electronics Converters and Converter Arrangement

(71) Applicant: Siemens Aktiengesellschaft, München (DE)

(72) Inventors: Monika Poebl, München (DE); Thomas Komma, Leipzig (DE)

(73) Assignee: Siemens Aktiengesellschaft, München (DE)

(21) Appl. No.: 16/767,503

(22) PCT Filed: Nov. 2, 2018
(86) PCT No.: PCT/EP2018/080020

§ 371 Date: May 27, 2020

(30) Foreign Application Priority Data
Nov. 28, 2017 (DE) 10 2017 221 267.5

(51) Int. Cl. H01F 27/34; H02M 3/158; H01F 27/24; H01F 27/28

(52) U.S. Cl. CPC H01F 27/34; H01F 27/2847; H01F 27/24; H02M 3/1582

(57) ABSTRACT

Various embodiments include a winding arrangement for at least two interleaved-switching power-electronics converters comprising: a winding core with two partial elements separated from each other by an air gap in the region of mutually facing end surfaces and two windings wound around the winding core to compensate for a DC component of a magnetic flux produced by the two windings during operation of the power-electronics converter. The two windings include strip windings. A winding window of each respective winding is arranged in a segment of the winding core that does not span the air gap.

### CROSS-REFERENCE TO RELATED APPLICATIONS

This application is a U.S. National Stage Application of International Application No. PCT/EP2018/080020 filed Nov. 2, 2018, which designates the United States of America, and claims priority to DE Application No. 10 2017 221 267.5 filed Nov. 28, 2017, the contents of which are hereby incorporated by reference in their entirety.

### TECHNICAL FIELD

The present disclosure relates to power electronics. Various embodiments include a winding arrangement for at least two interleaved-switching power-electronics converters and/or converter arrangements comprising at least two interleaved-switching power-electronics converters and a winding arrangement.

### BACKGROUND

Power-electronics circuits such as boost converters or buck converters can be distributed over a plurality of identically designed power-electronics converters and operated in parallel. The power-electronics converters are then controlled in what is known as “interleaved mode”, in which the active circuit elements are switched at the same duty cycle but offset in time by the number of power-electronics converters provided in parallel. For two power-electronics converters arranged in parallel (also known as stages), the switching elements thereof are operated with an offset of 50%. For three stages, the offset is 33%.

### SUMMARY

The teachings of the present disclosure describe windings arrangement for at least two interleaved-switching power-electronics converters and converter arrangements comprising at least two interleaved-switching power-electronics converters and a winding arrangement, which allow a reduction in the winding losses and an increase in the current that can be carried through the winding. For example, some embodiments include a winding arrangement for at least two interleaved-switching power-electronics converters (1) comprising: a winding core (100; 200) comprising at least two partial elements (110, 120; 210, 220), wherein the two partial elements (110, 120; 210, 220) are separated from each other by an air gap (131, 132; 231) in the region of mutually facing end surfaces (114, 124; 115, 125; 217, 227); and at least two windings (116, 126; 218, 228), which are wound around the winding core (100; 200) in such a way that a DC component of a magnetic flux, which is produced by the at least two windings (116, 126; 218, 228) during operation of the power-electronics converter (1), is compensated. The at least two windings (116, 126; 218, 228) are in the form of strip windings and a winding window of each of the at least two windings (116, 126; 218, 228) is arranged in a segment of the winding core (100; 200) that does not span the air gap (131, 132; 231).

In some embodiments, the winding axes of the at least two windings (116, 126; 218, 228) run parallel to one another.

In some embodiments, a size of the mutually facing end surfaces (114, 124; 115, 125; 217, 227) is determined solely by the height of the ripple current arising during operation of the power-electronics converter (1).

In some embodiments, the winding axes of the at least two windings (116, 126) extend perpendicular to an extension direction of the air gap (131, 132).

In some embodiments, the at least two partial elements (110, 120) have the shape of a U comprising a middle portion (111, 121) and arm portions (112, 113; 122, 123), which extend in parallel from the opposite ends of the middle portion (111, 121), wherein the winding window of the at least two windings (116, 126) extends in the region of the middle portion (111, 121).

In some embodiments, the at least two partial elements (110, 210) lie opposite one another such that the mutually facing end surfaces (114, 124; 115, 125) of facing arms are spaced apart from one another by an air gap (131, 132).

In some embodiments, a length (1) of the air gap (131, 132) is greater than or equal to a specified minimum length, as a result of which a leakage path (ϕS), along which an AC component of the magnetic flux extends, runs parallel to the winding axes of the at least two windings (116, 126).

In some embodiments, the winding axes of the at least two windings (216, 226) extend parallel to an extension direction of the air gap (231).

In some embodiments, the at least two partial elements (210, 220) have the shape of an E having a central portion (211, 221), arm portions (212, 213, 222, 223), which extend in parallel from the opposite ends of the central portion (211, 221), and a middle portion (214, 224), which extends parallel to the arm portions (212, 213, 222, 223), wherein the middle portion (214, 224) is shorter than the two arm portions (212, 213, 222, 223) of the same partial element (210, 220).

In some embodiments, the at least two partial elements (210, 220) are arranged opposite such that end surfaces of mutually facing arm portions of the at least two partial elements (210, 220) lie opposite, in each case forming a small air gap (l₁, l₂).

In some embodiments, the air gap (231) is formed in the region of the two mutually facing middle portions (214, 224).

In some embodiments, a winding window is formed in the region of the mutually facing arm portions in each case.

As another example, some embodiments of the teachings herein include a converter arrangement comprising at least two interleaved-switching power-electronics converters (1) and a winding arrangement, characterized in that the winding arrangement is designed as described above.

### BRIEF DESCRIPTION OF THE DRAWINGS

The teachings herein are described in greater detail below with reference to exemplary embodiments in the drawings. The same elements are denoted by the same reference signs in the drawings, in which:

FIG. 1 shows an equivalent electrical circuit of a converter arrangement consisting of two power-electronics converters (stages), embodied as a buck-boost converter;

FIG. 2 shows a schematic diagram of a winding arrangement in which a shared winding core is provided for the inductances of the two power-electronics converters;

FIG. 3 shows a schematic diagram of the winding arrangement of FIG. 2, illustrating a resultant magnetic leakage path;

FIG. 4 shows an example winding arrangement incorporating teachings of the present disclosure; and

FIG. 5 shows an example winding arrangement incorporating teachings of the present disclosure.

### DETAILED DESCRIPTION

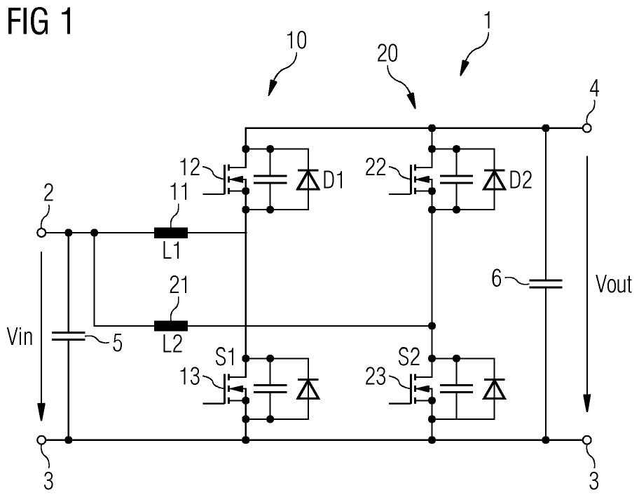

FIG. 1 shows by way of example a buck-boost converter consisting of two identical stages. The converter arrangement 1 shown in FIG. 1 comprises a first power-electronics converter, denoted by the reference sign 10, and a second power-electronics converter, denoted by the reference sign 20. The first power-electronics converter 10 comprises a winding 11 of inductance L1, a first switching element 12, and a second switching element 13. Analogous thereto, the second power-electronics converter 20 comprises a winding 21 of inductance L2, a first switching element 22, and a second switching element 23 connected in series therewith. The windings 11, 21 in particular have the same inductances L1, L2.

The series circuit composed of first and second switching elements 12, 13 and 22, 23 respectively, of both the first and the second power-electronics converters 10, 20, is connected between an output terminal 4 and a reference-potential terminal 3. A (smoothing) capacitor is additionally arranged in parallel with the power-electronics converters 10, 20, and thus between the reference-potential terminal 3 and the output terminal 4. A node between the first switching element 12 and the second switching element 13 of the first power-electronics converter 10 is connected via the winding 11 to a supply-potential terminal 2. Analogous thereto, a node between the first switching element 22 and the second switching element 23 of the second power-electronics converter 20 is connected via the winding 21 to the supply-potential terminal 2. A capacitor 5 is connected between the supply-potential terminal 2 and the reference-potential terminal 3.

While an input voltage Vin lies between the supply-potential terminal 2 and the reference-potential terminal 3, an output voltage Vout can be taken off between the output terminal 4 and the reference-potential terminal 3.

During operation of the power-electronics converter 1, in the implementation as a buck-boost converter, only the switching function of the second switching elements 13 and 23 (therefore in FIG. 1 also labelled as S1 and S2) is used, whereas the first switching elements 12, 22 are permanently in the off state, and therefore only their diode properties when they are operated in the off state are used (which is identified in FIG. 1 by D1 and D2).

The inductances L1 and L2 are formed by separate winding arrangements, in which the respective windings 11 and 12 are each mounted on an individual winding core. In principle it is possible to replace the inductances L1 and L2 by a single inductance coupled by a shared winding core. This configuration requires a smaller overall volume of the winding arrangement because it is possible to compensate the DC component of the magnetic flux in the winding core and thereby significantly reduce the magnetic core cross-section.

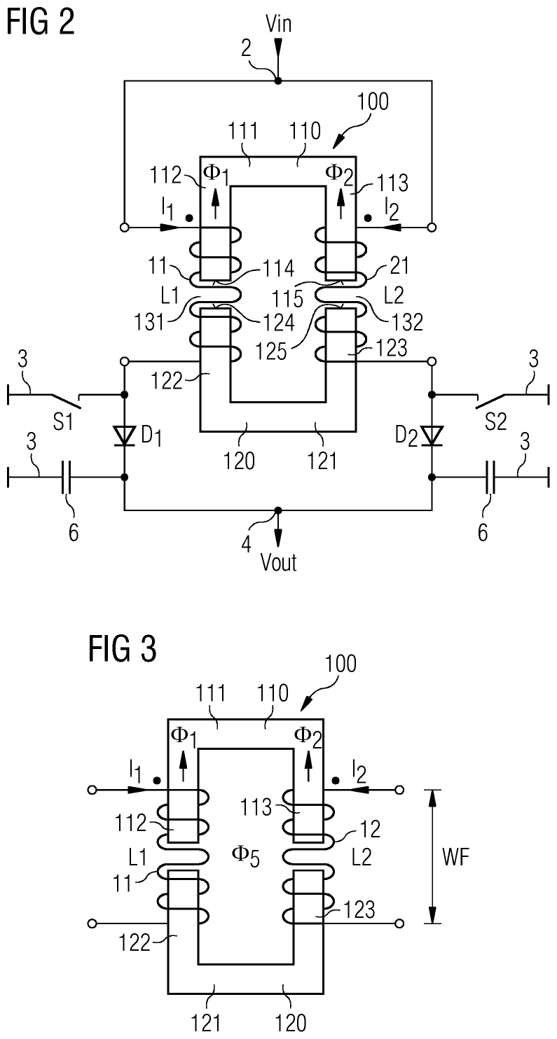

This approach is shown schematically in FIG. 2. The figure shows a winding arrangement having a winding core 100, which comprises a first U-shaped partial element 110 and a correspondingly designed second U-shaped partial element 120. The first and second partial elements 110, 120 each comprise a middle portion 111, 121, from the opposite ends of which extend parallel-extending arm portions 112, 113 and 122, 123. Mutually facing end surfaces 114, 124 of the arm portions 112, 122 and mutually facing end surfaces 115, 125 of the arm portions 113, 123 are spaced apart from one another by respective air gaps 131 and 132.

The winding for forming the first inductance L1 is provided along the axially arranged arm portions 112 and 122 of the first and second partial elements 110 and 120. The winding 12 for forming the second inductance L2 extends in a corresponding manner over the arm portions 113 and 123 of the first and second partial elements 110 and 120, which arm portions are arranged axially in a row. As is readily apparent, the windings 11 and 12 bridge the respective air gaps 131 and 132 formed in each case between the mutually facing arm portions.

The elements S1, D1 and S2, D2 described and shown in FIG. 1, and their connection in relation to the output terminal 4 and the reference-potential terminal 3, are shown in addition to the winding arrangement. Thus FIG. 2 shows an arrangement in which, for two parallel-switched stages of a converter arrangement, the windings thereof are mounted on the arm portions of the winding core that are on the sides containing the air gaps. This produces the desired effect described in the introduction of being able, by means of this arrangement, to compensate the DC component of the magnetic flux in the winding core. This is illustrated by the magnetic fluxes ϕ₁ and ϕ₂ indicated in the first partial element 110, which run in opposite directions as a result of the currents i1 and i2 flowing through the windings 11, 12.

The compensating effect of the magnetic fluxes ϕ₁ and ϕ₂ means that the inductance needed to implement the function of the power-electronics circuit (in this case a buck-boost converter) comes solely from a leakage inductance ϕ_{S}, which results from an undefined leakage flux running along the leakage path indicated in FIG. 3 by the arrows running from top to bottom. The elements S1, D1 and S2, D2 and their connection in relation to the output terminal 4 and the reference-potential terminal 3 are not shown in FIG. 3 for the sake of clarity.

Field-bulging (not shown) resulting from the leakage inductance ϕ_{S} across the air gaps 131 and 132 makes a significant contribution to winding losses, which is undesirable, and which is why a relatively expensive Litz-wire winding must be used for implementing the windings 11, 12. At higher powers or currents through the power-electronics circuits, however, this can lead to constraints as a result of a winding window WF that cannot be made sufficiently large. The winding window WF is obtained from the width of a winding body of the respective windings 11 and 12 that extends in an axial direction of the arm portions.

Some embodiments of the teachings herein include a winding arrangement for at least two interleaved-switching power-electronics converters which comprises a winding core comprising at least two partial elements, and at least two windings. The two partial elements of the winding core are separated from each other by an air gap in the region of mutually facing end surfaces. The at least two windings are wound around the winding core in such a way that a DC component of the magnetic flux, which is produced by the at least two windings during operation of the power-electronics converter, is compensated. According to the invention, the at least two windings are in the form of strip windings. A winding window of each of the at least two windings is arranged in a segment of the winding core that does not span the air gap.

In some embodiments, the winding arrangement for at least two interleaved-switching power-electronics converters is realized in that the segments of the winding core that are typically not used are each provided with a winding. Thus, the windings are rotated through 90° with respect to the arrangement from the prior art described in the introduction (FIGS. 2 and 3). The arrangement of the windings in a segment of the winding core that does not span the air gap avoids the negative impacts of the field-bulging in the vicinity of the air gap, whereby impacts on winding losses can be avoided. It is hence possible to use for high-current applications a strip winding instead of a Litz-wire winding.

By reducing the winding losses, the winding arrangement can be operated with larger currents. Furthermore, the winding arrangement can be realized more cheaply because a strip winding is significantly less expensive than a Litz-wire winding. Using a strip winding can in turn efficiently reduce the losses resulting from the high DC component of the winding current. Reducing the DC component of the magnetic flux as a result of compensation during operation of the power-electronics converters allows a reduction in the cross-section of the winding core, whereby a further reduction in the installation space is possible.

The inductance required to operate the converter arrangement is achieved by the theoretically undesirable leakage field described in the introduction. In some embodiments, the theoretically undesirable leakage field is deliberately increased, with the effect of reducing the losses that are induced in the strip winding. In some embodiments, the winding axes of the at least two windings run parallel to one another. For two interleaved-switching power-electronics converters and a corresponding number of two windings (i.e. one winding per power-electronics converter), the windings are arranged on opposite arm segments, neither of which spans an air gap.

A size of the mutually facing end surfaces is determined by the height of the ripple current arising during operation of the power-electronics converter. In other words, the current amplitude resulting from the difference in the DC component and the AC component of the current is relevant to the dimensioning of the area of the cross-section of the winding core.

In some embodiments, the winding axes of the at least two windings extend perpendicular to an extension direction of the air gap. In some embodiments, the at least two partial elements have the shape of a U comprising a middle portion and arm portions, which extend in parallel from the opposite ends of the middle portion, wherein the winding window of the at least two windings extends in the region of the middle portion. Each partial element in the shape of a U can be formed from one U-shaped part (i.e. a single piece), two L-shaped parts or three I-shaped parts. In the case of more than one part, the parts must be joined to one another such that there is no air gap between the parts in order to prevent an unwanted impact on the magnetic flux. Two U-shaped partial elements arranged opposite one another produce two air gaps (of equal length), each in the region of the mutually facing end surfaces of two associated arm portions.

In some embodiments, the at least two partial elements lie opposite one another such that the mutually facing end surfaces of facing arms are spaced apart from one another by an air gap. As a result, the winding core hence has the shape of a ring, but which is interrupted on each of two opposite sides by an air gap.

In some embodiments, a length of the air gap (or air gaps) is greater than or equal to a specified minimum length, as a result of which the leakage path, along which an AC component of the magnetic flux extends, runs parallel to the winding axes of the at least two windings. The air gap is hence selected such that the magnetic leakage flux does not enter from one partial element into the other partial element, but instead runs from one arm portion of a partial element to its other arm portion.

In some embodiments, the winding axes of the at least two windings extend parallel to an extension direction of the air gap. In particular, the at least two partial elements have the shape of an E having a central portion, arm portions, which extend in parallel from the opposite ends of the central portion, and a middle portion, which extends parallel to the arm portions, wherein the middle portion, which lies between the two parallel arm portions, is shorter than the two arm portions of the same partial element.

If the at least two partial elements are arranged opposite such that end surfaces of mutually facing arm portions of the at least two partial elements lie opposite, in each case forming a small air gap, then this results in the desired (comparatively larger or longer) air gap, across which the leakage path runs, between the mutually associated middle portions of the two partial elements, which middle portions are arranged in an axial direction. This makes it possible to increase the resultant leakage inductance.

In some embodiments, a winding window is formed in the region of the mutually facing arm portions in each case. In other words, this means that the winding window extends over an arm portion of the one partial element and the other arm portion of the other partial element, which arm portion is arranged in the same axial direction.

In some embodiments, the converter arrangement is characterized in that the winding arrangement is designed in accordance with the description given here. The variants described below of a winding arrangement 100 incorporating the teachings herein are described by way of example for the power-electronics circuit comprising two power-electronics converters that is shown in FIG. 1.

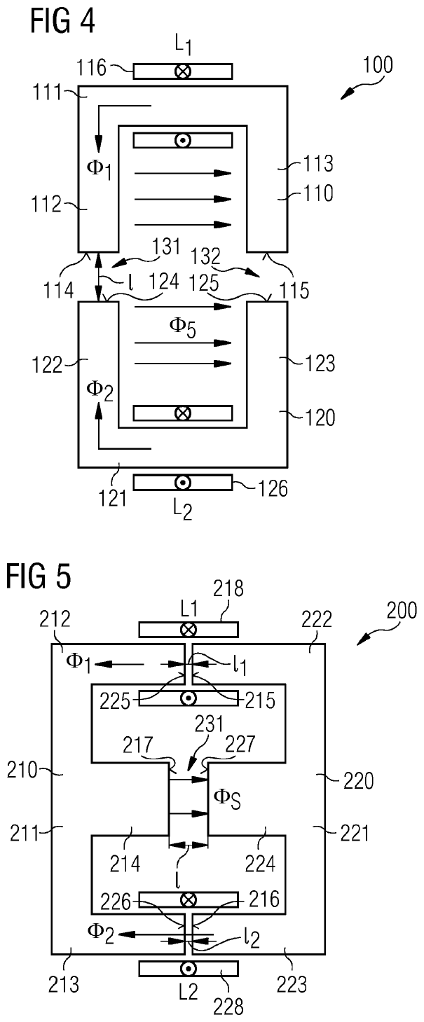

In some embodiments, like that shown in FIG. 4, a winding core 100 comprises two U-shaped partial elements 110, 120, and hence corresponds in design to the winding core shown in connection with FIGS. 2 and 3. The first partial element 110 comprises a middle portion 111, from the opposite ends of which extend two arm portions 112, 113 in parallel towards the second partial element 120. The second partial element 120 has an identical shape to the shape of the first partial element 110. The second partial element 120 correspondingly comprises a middle portion 121, from the opposite ends of which extend two arm portions 122, 123 in parallel towards the first partial element 110.

The arm portions 112, 113 of the first partial element 110 and the arm portions 122, 123 of the second partial element 120 comprise respective end surfaces 114, 115 and 124, 125. The two partial elements 110, 120 are arranged opposite such that the end surfaces 114 and 124 of the arm portions 112, 122 lie opposite, and the end surfaces 115, 125 of the arm portions 113 and 123 lie opposite. Air gaps 131 and 132 of identical length 1 are thereby formed between the respective end surfaces 114, 124 and 115, 125. The length 1 is greater than a predetermined minimum length, which can be determined, for example, by trials or numerical calculation. The minimum length is such that no leakage flux can pass from one partial element to the other partial element.

A first strip winding 116 is wound around the middle portion 111 of the first partial element 110. A second strip winding 126 is correspondingly formed around the middle portion 121 of the second partial element 120. The current flows into the strip windings 116, 126 in such a way as to produce the magnetic flux running in opposite directions and shown by the arrows ϕ₁ and ϕ₂ in the two partial element 110, 120.

In some embodiments, the dimensioning of the gap length 1 of the air gaps 131, 132 results in a leakage field ϕ_{S}, which in neither case runs via the air gaps 131, 132, but for the first partial element 110 is oriented from the first arm portion 112 to the arm portion 113, and for the second partial element 120 is oriented from the arm portion 122 to the arm portion 123. The size of the leakage field ϕ_{S} can be adjusted by the length 1 of the air path. The theoretically undesirable leakage field ϕ_{S}, but which is produced artificially here, provides the inductance required for operating the power-electronics circuit.

By virtue of the arrangement of the windings 116, 126 on the middle portions 111, 122, however, field-bulging arising in the vicinity of the air gap does not affect the winding losses. This is why it is possible to use inexpensive strip windings 116, 126, which are also well-suited to high-current applications. In particular, the strip winding can efficiently reduce the losses resulting from the high DC component of the winding current.

FIG. 5 shows a second variant of a winding arrangement incorporating the teachings herein for two power-electronics converters by way of example. The winding core 200 likewise comprises two partial elements 210, 220. The two partial elements 210, 220 have the shape of an E. For the first partial element 210, a first arm portion 222 and a second arm portion 223 extend from a central portion 221 (which runs from top to bottom in the plane of the page), and run from the opposite ends thereof in parallel towards the second partial element 220. A middle portion 214 extends in parallel with the arm portions 212, 213 towards the second partial element 220, which middle portion has a shorter length than the two parallel-running arm portions 212, 213.

The second partial element 220 correspondingly comprises a central portion 221 (which runs from top to bottom in the plane of the page), from the opposite ends of which extend two arm portions 222, 223, which extend in parallel towards the first partial element 210. A middle portion 224 extends in parallel with the arm portions 222, 223 towards the first partial element 210.

The first and the second partial elements 210, 220 have an identical design. The first and the second partial elements 210, 220 are joined to one another at the end surfaces 215, 225 and 216, 226 of mutually associated arm portions 212, 222 and 213, 223, in each case forming a small air gap l₁, l₂. In this arrangement, the middle portions 214, 224 come to lie in an axial direction. The shorter length of the middle portions 214, 224 results in an air gap 231, which extends in parallel with the winding axes of the windings 218, 228, of length 1, which is greater than the air gap l₁, l₂.

As is readily apparent from FIG. 5, a first strip winding 218 for forming an inductance L₁ is in the form of a strip winding and extends along the axially arranged arm portions 212, 222. The winding 228 extends over the arm portions 213, 223 in an axial direction.

The windings 218, 228 are energized such that a DC component of the magnetic flux extends in the directions labelled by the arrows ϕ₁, ϕ₂ in FIG. 5, and is compensated. The leakage field ϕ_{S} runs over the air gap 231 from the middle portion 214 to the middle portion 224 of the second partial element 220. By virtue of the core shape shown in FIG. 5, which has a separate leakage path, it is possible to increase the resultant leakage inductance because the magnetic reluctance can be reduced. This results in a higher inductance value. The optimum length of the air gap 231 and the size of the respective end surfaces 217 and 227 of the middle portions 214, 224 can be determined by trials or simulation.

Using a winding core having two E-shaped partial elements produces an additional defined leakage field, by means of which it is possible to increase significantly the value of the achievable leakage compared with conventional core geometries.

What is claimed is:

1. A winding arrangement for at least two interleaved-switching power-electronics converters, the arrangement comprising:
a winding core with two partial elements separated from each other by an air gap in the region of mutually facing end surfaces; and
two windings wound around the winding core to compensate for a DC component of a magnetic flux produced by the two windings during operation of the power-electronics converter;
wherein the two windings include strip windings; and
a winding window of each respective winding is arranged in a segment of the winding core that does not span the air gap.

2. The winding arrangement as claimed in claim 1, wherein the respective winding axes of the two windings run parallel to one another.

3. The winding arrangement as claimed in claim 1, wherein a size of the mutually facing end surfaces corresponds to a height of the ripple current arising during operation of the power-electronics converter.

4. The winding arrangement as claimed in claim 1, wherein the respective winding axes of the two windings both extend perpendicular to an extension direction of the air gap.

5. The winding arrangement as claimed in claim 4, wherein:
the two partial elements each have comprise a U with a middle portion and arm portions extending in parallel from the opposite ends of the middle portion;
the respective winding window of each of the two windings extends in the region of the middle portion.

6. The winding arrangement as claimed in claim 4, wherein the two partial elements lie opposite one another so the mutually facing end surfaces of facing arms are spaced apart from one another by an air gap.

7. The winding arrangement as claimed in claim 4, wherein a length of the air gap is greater than or equal to a specified minimum length defining a leakage path (ϕS) along which an AC component of the magnetic flux extends and running parallel to the respective winding axes of the two windings.

8. The winding arrangement as claimed in claim 1, wherein the respective winding axes of the two windings extend parallel to an extension direction of the air gap.

9. The winding arrangement as claimed in claim 8, wherein:
the two partial elements each have the shape of an E with a central portion, arm portions extending in parallel from the opposite ends of the central portion, and a middle portion extending parallel to the arm portions;
the respective middle portion is shorter than the two arm portions of the respective partial element.

10. The winding arrangement as claimed in claim 9, wherein the two partial elements are arranged opposite each other so end surfaces of mutually facing arm portions of the two partial elements form a second air gap.

11. The winding arrangement as claimed in claim 9, wherein the air gap is disposed in the region of the two mutually facing middle portions.

12. The winding arrangement as claimed in claim 9, further comprising a winding window in the region of the mutually facing arm portions of each winding.

13. A converter arrangement comprising:
two interleaved-switching power-electronics converters; and
a winding arrangement comprising:
a winding core with two partial elements separated from each other by an air gap in the region of mutually facing end surfaces; and
two windings wound around the winding core to compensate for a DC component of a magnetic flux produced by the two windings during operation of the power-electronics converter;
wherein the two windings include strip windings; and
a winding window of each respective winding is arranged in a segment of the winding core that does not span the air gap.
